(19) United States
(12) Patent Application Publication
(10) Pub. No.: US 2007/0166128 A1
(43) Pub. Date: Jul. 19, 2007

(54) Nut and plate assembly

(76) Inventors: Martin J. Nilsen, Hampshire, IL (US); Michael E. Ward, Geneva, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/598,365

(22) Filed: Nov. 13, 2006

Related U.S. Application Data
(60) Provisional application No. 60/758,660, filed on Jan. 13, 2006.

(51) Int. Cl. F16B 37/04; F16B 43/00

(52) U.S. Cl. 411/533; 411/177

(57) ABSTRACT

A nut assembly includes a nut and a plate. The nut includes a portion disposed in the plate, through a hole in the plate. An outer surface of the nut is expanded outwardly to engage surfaces forming the hole. Axial compression is used in a method of the present invention for securing the nut in the washer.

### CROSS-REFERENCE TO RELATED APPLICATIONS

The present regular United States patent application claims the benefits of U.S. Provisional Application Ser. No. 60/758,660, filed on Jan. 13, 2006.

### FIELD OF THE INVENTION

The present invention pertains generally to fasteners, and, more particular, the present invention pertains to nut-type fastener assemblies that include a nut and a plate, washer or other part connected therewith.

### BACKGROUND OF THE INVENTION

Threaded fastening assemblies including nuts and plates, washers or other parts connected thereto commonly are provided for specialized applications. To facilitate final assembly of devices, it is known to pre-assemble portions of the fastener with other associated parts. For example, a nut may be associated with a washer or other plate-like structure prior to final assembly. Thereafter the subassembly including the nut can be installed and a threaded fastener secured to the nut.

It is advantageous to provide the nut and the associated part secured relative to each other so that the associated parts can be handled as one piece. For example, it is known to secure a nut to a plate or washer, and then coat the assembled components prior to final installation in a device. It is important that the nut and plate be oriented properly, particularly when a coating such as rubber or the like is applied, which inhibits any later adjustment.

It is known to attach nuts to other parts by welding, and by interference fit using knurls. However, knurling may require an additional step in the manufacture of each the nut and the associated component, such as a plate or washer, thereby adding significantly to manufacturing costs. Welding can work effectively, but requires suitable fixtures, welding equipment and a welding step in the assembly process. Again, a welding process can add significantly to the costs for providing nuts associated with washers or other parts.

### SUMMARY OF THE INVENTION

The present invention provides a nut assembly and a manufacturing method therefore whereby lateral expansion of the nut secures the nut in the other component.

In one aspect thereof, the present invention provides a fastener assembly with a body of metal including a hole formed therein, the body having a first face and a second face and the hole extending through the body from the first face to the second face. The hole is defined by an edge surface extending between the first and second faces, the hole having a peripheral shape of a first size on the first face, and the hole having a similar peripheral shape of a smaller size on the second face. At least a portion of the edge surface tapers inwardly from the first face toward the second face. A fastener is disposed in the hole and has an outer surface conforming to the peripheral shape at the second face, and a portion of the outer surface being outwardly deformed against the tapering edge surface.

In another aspect thereof, the present invention provides a method of forming a fastener assembly with steps of forming a hole in a metal body between a first face and a second face of the body, including forming a side edge of the hole having at least a portion thereof at an angle with respect to the first and second faces such that a size of the hole on the first face is larger than a size of the hole on the second face. The method further includes positioning a fastener in the hole; and compressing the fastener axially and deforming a portion of the fastener outwardly against the side edge of the hole.

In a still further aspect thereof, the present invention provides a method of forming a nut and plate assembly with steps of punching a hole through a plate from a first face to a second face of the plate; positioning a nut in the punched hole; and expanding an outer surface of the nut against an edge of the hole by applying compressive force against the nut.

An advantage of the present invention is providing a nut assembled with a plate, washer or other part that can be manufactured and assembled in a cost effective manner.

Another advantage of the present invention is providing a process whereby a nut can be secured to another part using simple, available metal forming processes.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is an exploded view of a nut and plate assembly in accordance with the present invention;

FIG. 2 is a cross-sectional view of the nut and plate assembly shown in FIG. 1, illustrating an early stage of the assembly process;

FIG. 3 is a cross-sectional view similar to that of FIG. 2, but illustrating a final step in the assembly process; and

FIG. 4 is a cross-sectional view similar to that of FIG. 3, but illustrating an alternative step in the assembly process.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

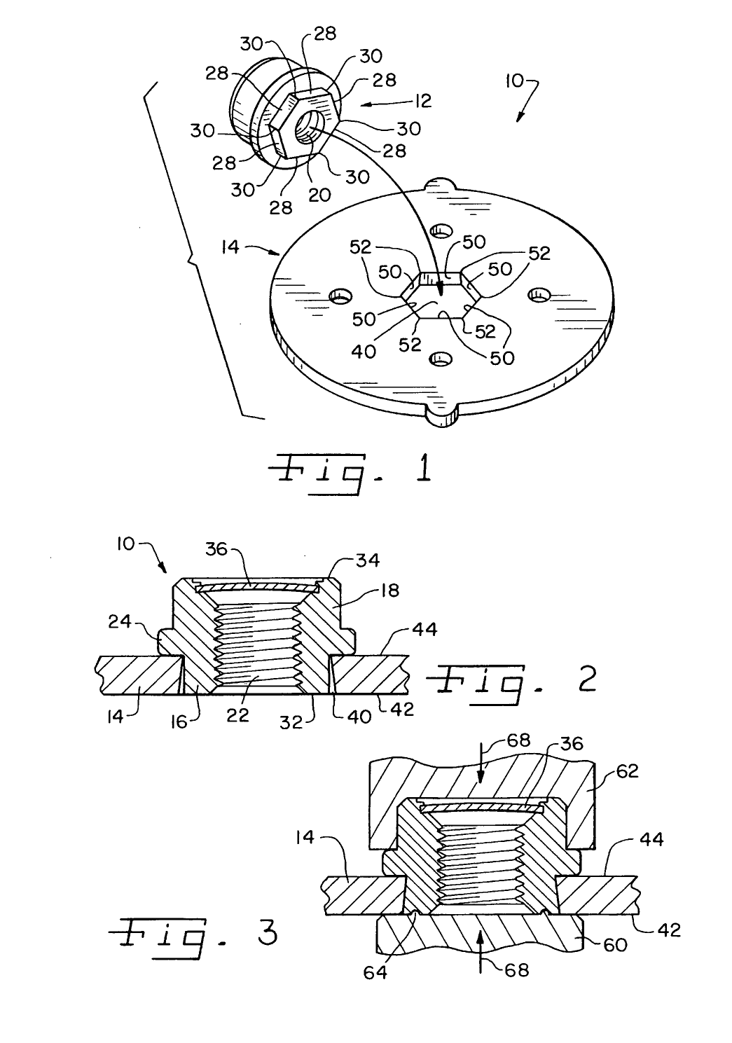

Referring now more specifically to the drawings and to FIG. 1 in particular, a nut assembly 10 is shown. Nut assembly 10 includes a nut 12 and a second part 14. In the exemplary embodiment, second part 14 is a plate or washer 14; however, it should be understood that the present invention can be used with different types of nuts, different types of second parts and the like. The specific structures shown are merely exemplary of suitable structures.

Nut 12 includes a head 16 and a shank 18. A central bore 20 extending through nut 12 is provided with a thread or threads 22 for receiving and engaging the complementary threads of a male threaded fastener component (not shown). A flange 24 is provided between head 16 and shank 18. Head 16, shank 18 and flange 24 are a monolithic body, and may be formed by using suitable nut forming techniques for the metal being used. Such techniques may include casting, molding, machining or other mass production techniques useful for the material used in nut 12.

Head 16 has a circumferential shape, which in the exemplary embodiment is a hex shape as known for use on nuts, bolt heads and the like. Accordingly, head 16 includes six flat surfaces or facets 28, with adjacent facets 28 defining ridges 30. However, other circumferential shapes also can be used. Generally, non-round shapes are preferred.

Shank 18 is shown as a substantially tube-like structure, but also may be of other configurations. Shank 18 is contiguous with head 16, such that a first nut end 32 is defined at head 16 and a second nut end 34 is defined at shank 18, with first and second nut ends 32, 34 being at opposite ends of nut 12. In the exemplary embodiment, nut 12 is provided with a cap or plug 36 inserted into shank 18 to protect thread 22 during the application of a coating, such as rubber or plastic, on nut assembly 10.

Second part or plate 14 is a substantially circular metal body, but may be of other shapes as required. Plate 14 is provided sufficiently large to abut against flange 24, with head 16 disposed in plate 14. Accordingly, plate 14 is provided with a hole 40 extending between first and second faces 42, 44 on opposite sides of hole 40. Hole 40 is configured with a peripheral shape similarly to head 16, to receive head 16 therein in close fitting relationship. Accordingly, in the exemplary embodiment, since head 16 has a hex-shape including six facets 28 and six ridges 30; hole 40 includes six edge surfaces 50, with adjacent edge surfaces 50 forming peaks 52 defined therebetween.

Surfaces 50 are not perpendicular to faces 42 and 44 throughout the lengths of surfaces 50. Accordingly, a peripheral end shape of hole 40 at first face 42 is of a first size. At second face 44 the peripheral shape of hole 40 is substantially similar to that at first face 42, but of slightly smaller size. In standard punching processes that may be used advantageously to form hole 40 in plate 14, at least a portion of surfaces 50 and/or peaks 52 are angularly oriented due to the punching process. While such angular orientation may extend throughout the thickness of plate 14, in other instances only a segment of surfaces 50 and/or peaks 52 are of such angular disposition. In FIGS. 2-4, the angular orientation is exaggerated for illustrative purposes such that edge surfaces 50 angle inwardly from face 42 toward face 44.

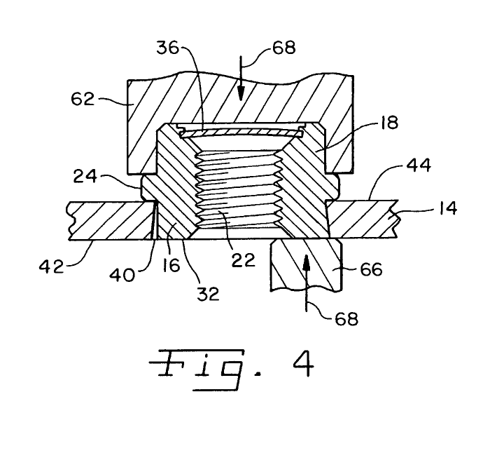

When nut 12 is disposed in plate 14, with head 16 aligned and arranged in hole 40, minimal clearance is present at second face 44. As shown in FIG. 2, an angular space is provided between the nut 12 and plate 14 along the tapering surface of hole 40. By compressing nut 12 axially, a portion of head 16 can be caused to deform by expanding laterally outwardly, filling at least a portion of the angular extent of surfaces 50 or peaks 52. FIGS. 3 and 4 show nut 12 after outward expansion against surfaces defining hole 40.

FIG. 3 illustrates an embodiment of the present invention in which first and second dies 60, 62 are applied against end 32, and end 34 and/or flange 24, respectively. Axial force is applied by a substantially continuous ring 64 near the periphery of end 32, and a portion of facets 28 or ridges 30 expand laterally outwardly against the tapered edge surfaces 50 or peaks 52 defining hole 40.

FIG. 4 illustrates another embodiment of the present invention in which a punch 66 applies axial force at one or more discrete location against first nut end 32. For example, punch 66 can be positioned substantially at one or more of the ridges 30 to expand the ridge outwardly against a peak 52. Punch 66 can be positioned at a plurality of locations during separate discrete compressing steps, one after another. Alternatively, a plurality of punches 66 can be used simultaneously against first nut end 32.

By positioning flange 24 against second face 44 of plate 14 and expanding head 16 against edge surface 50 or peak 52 near first face 42, plate 14 is effectively trapped between flange 24 and the outwardly expanded portion of head 16. Nut 12 can not be easily removed or extracted because of the interference caused between the outwardly expanded portion of head 16 and the tapered edge surface 50 or peak 52 defining hole 40.

In a manufacturing process of the present invention, hole 40 is formed by punching. Punching is performed from face 44 toward face 42 such that a peripheral shape of hole 40 on first face 42 is of a first size and hole 40 has a peripheral shape at second face 44 of a substantially similar shape of a slightly smaller size. Accordingly, at least portions of edge surfaces 50 and/or peaks 52 angle inwardly from first face 42 toward second face 44. Nut 12 is inserted into hole 40 from second face 44 toward first face 42 until flange 24 abuts against second face 44. A peripheral shape of an outer surface of nut 12 conforms to hole 40 at second face 44 in close fitting relationship. Nut 12 is secured in plate 14 by axially compressing nut 12 either in a substantially continuous pattern against first end 32 near a peripheral edge thereof, or by applying force at one or more smaller discrete location against first end 32. The compressive force against nut 12, indicated by arrows 68, causes outward deformation of a portion of head 16, such that the outer surface of nut 12 engages edge surfaces 50 and/or peaks 52 in hole 40.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A fastener assembly comprising:
a body of metal including a hole formed therein, said body having a first face and a second face and said hole extending through said body from said first face to said second face;
said hole being defined by an edge surface extending between said first and second faces, said hole having a peripheral shape of a first size on said first face, and said hole having a similar peripheral shape of a smaller size on said second face;
at least a portion of said edge surface tapering inwardly from said first face toward said second face; and
a fastener disposed in said hole, said fastener having an outer surface conforming to said peripheral shape at said second face, and a portion of said outer surface being outwardly deformed against said edge surface.

2. The fastener assembly of claim 1, said body being a plate.

3. The fastener assembly of claim 1, said fastener being a nut.

4. The fastener assembly of claim 3, said body being a plate.

5. The fastener assembly of claim 1, said portion of said outer surface being outwardly deformed against said tapering portion of said edge surface.

6. A method of forming a fastener assembly, comprising:
forming a hole in a metal body between a first face and a second face of the body;
said forming the hole including forming a side edge of the hole having at least a portion thereof at an angle with respect to the first and second faces such that a size of the hole on the first face is larger than a size of the hole on the second face;
positioning a fastener in the hole; and
compressing the fastener axially and deforming a portion of the fastener outwardly against the side edge of the hole.

7. The method of claim 6, said compressing including applying force in a plurality of discrete locations on at least one end of the fastener.

8. The method of claim 6, said compressing including applying axial force in a substantially continuous pattern against an end of the fastener.

9. The method of claim 6, said compressing including applying axial force against an end of the fastener near an edge thereof.

10. The method of claim 6, including providing said fastener as a nut.

11. The method of claim 6, including providing the fastener as a nut including a flange, and said positioning step including arranging the nut with the flange against a surface of the body.

12. The method of claim 6, said forming a hole being punching a hole.

13. A method of forming a nut and plate assembly, comprising:
punching a hole through a plate from a first face to a second face of the plate;
positioning a nut in the punched hole; and
expanding an outer surface of the nut against an edge of the hole by applying compressive force against the nut.

14. The method of claim 13, including applying force in a plurality of discrete locations on at least one end of the nut.

15. The method of claim 13, including applying axial force near a periphery of an end of the nut.

16. The method of claim 15, including applying said axial force in a substantially continuous force pattern against an end of the nut.

17. The method of claim 13, including inserting the nut into the hole from the first face to the second face, and abutting a flange of the nut against the first face.

18. The method of claim 17, including applying force in a plurality of discrete locations on at least one end of the fastener.

19. The method of claim 17, including applying axial force near a periphery of an end of the nut.

20. The method of claim 19, including applying said axial force in a substantially continuous force pattern against an end of the nut.
